(19) United States
(12) Patent Application Publication
(10) Pub. No.: US 2026/0100402 A1
(43) Pub. Date: Apr. 9, 2026

(54) APPARATUS AND METHOD FOR MAKING COILS, PREFERABLY FOR AN ELECTROCHEMICAL CELL INTENDED FOR BATTERY PRODUCTION

(71) Applicant: G.D S.P.A., Bologna (IT)

(72) Inventors: Andrea BIONDI, Bologna (IT); Enrico CAMPAGNOLI, Bologna (IT); Luca CAVAZZA, Bologna (IT)

(21) Appl. No.: 19/113,191

(22) PCT Filed: Sep. 19, 2023
(86) PCT No.: PCT/IB2023/059278

§ 371 Date: Mar. 19, 2025

(30) Foreign Application Priority Data
Sep. 20, 2022 (IT) 102022000019266

(51) Int. Cl. H01M 10/04; B65H 18/02; B65H 18/10

(52) U.S. Cl. CPC H01M 10/0409; B65H 18/0212; B65H 18/10; B65H 2511/212; B65H 2511/23; B65H 2601/421; B65H 2801/72

(57) ABSTRACT

An apparatus (100) for making coils, preferably for electrochemical cells intended for battery production, comprises a feed unit (2) configured to feed at least a first strip-shaped article (N1) intended to form a first coil (B1) and a second strip-shaped article (N2) intended to form a second coil (B2), a winding unit (1) comprising a plurality of winding heads (10) including at least a first winding head (11) configured to wind the first strip-shaped article (N1) and a second winding head (12) configured to wind the second strip-shaped article (N2) and at least one movement device (3) of said winding heads (10) configured to move said first winding head (11) and said second winding head (12). Said first winding head (11) and said second winding head (12) define respective winding axes (X1, X2) substantially parallel to each other. Said winding unit (1) is configured so as to define a separation plane (P), said separation plane (P) being substantially perpendicular to said winding axes (X1, X2) and being positioned so that said first strip-shaped article (N1) and said second strip-shaped article (N2) are located one on one side and the other on the opposite side of said separation plane (P) at least at said first winding head (11) and said second winding head (12).

The present invention relates to an apparatus for making coils, for example of the type formed by winding a strip-shaped article including a strip-shaped or a plurality of superimposed strips.

The invention is also directed to a method for making the same coils.

The present invention finds a preferred, although not exclusive, application in the sector of the production of electrochemical cells, for the manufacture of which a winding of a strip-shaped article is used.

In particular, in the pertinent technical sector, it is known to combine conductor strips and separator strips into layers in order to form an anode and cathode structure. The article made by overlapping the aforementioned layers is then wound, by means of special apparatuses, in the form of a coil and used for making the electrochemical cell itself.

The apparatuses may be provided with a winding core around which the strip-shaped article is wound to form the coil and, in some cases, they may provide for several winding cores, each intended for the winding of coils.

In this description as well as in the claims appended thereto, certain terms and expressions are deemed to have, unless otherwise expressly indicated, the meaning expressed in the following definitions.

The term “strip-shaped article” is intended to mean any solid product which, within an industrial production line, is presented in the form of an elongated strip or ribbon, i.e. an element in which the longitudinal extension is significantly greater than its transversal extension. The strip-shaped article can be formed by a single strip or ribbon of material, or by overlapping several strips arranged in layers.

The strip-shaped article also has characteristics such that a certain bending during its advancement along a relative production line is allowed.

The strip-shaped article can be made by superimposing alternating conductor and insulating layers on each other and be intended to form a sandwich to be wound for making a coil intended, for example, for the production of electrochemical cells or condensers.

The term “strip” is intended to mean any solid product which, within an industrial production line, is presented in the form of element or elongated ribbon, i.e. an element in which the longitudinal extension is significantly greater than its transversal extension. The strip can also be formed by a single layer or by several superimposed layers.

By way of example, the strip may be formed by a first layer of conductor or insulating material to which a coating is superimposed to form the second layer.

The term “winding” is intended to mean making a spiral structure by rotation of a strip, a ribbon or more generally of a strip-shaped article around an axis, a flat surface or another structure. By winding, the strip-shaped article will form one or more turns around the axis or the structure.

The term “coil” is intended to mean any spiral structure formed by winding a strip, a ribbon or more generally a strip-shaped article around an axis, a flat surface or another winding structure. Depending on the structure around which the strip-shaped article is wound, the overall shape of the coil may be substantially cylindrical rather than crushed or otherwise shaped.

As mentioned above, the coil can find application not only in the electrochemical cell sector but also in other sectors, such as for example in the conductor sector, within which coil-shaped structures can likewise be used.

The term “closed path” is intended to mean a path along which a winding head or other element travels in which the starting point and the end point of the path substantially coincide.

The term “continuously” refers to an expression of motion, which means an operation that takes place without interruption, without there being a stop or an interruption in the operation in question. In particular, with reference to the movement or feeding of a strip or of other element, the term “continuously”indicates that the strip is never stopped during its movement.

The term “substantially constant” referred to a measure or amount, such as for example the displacement speed of an object, is intended to mean that such measure or amount maintains, over time, a value which preferably varies by a maximum of ±10%, preferably by a maximum of ±5%, preferably by a maximum of ±2%.

The term “integral” referred to the movement of two or more elements, is intended to mean that these elements perform substantially the same movement and substantially simultaneously. In other words, two integral elements move together, as a single body, although they are not necessarily joined or bound to each other. It can in fact be provided that the respective movement systems of the two elements are coordinated so as to move, when necessary, the two elements together. Furthermore, it may be provided for the use of a temporary constraint between the two elements which, for example, joins them to each other in some steps, causing them to move together, and separates them again, making them movable independently of each other.

It should also be specified that by the expression “to displace an object between a first position and a second position” it is meant both the displacement from the first position to the second position and the displacement from the second position to the first position.

This definition applies in an analogous way to similar expressions of motion, such as for example to transfer or to move a generic object between two positions or between two zones or even between two different operating configurations.

The term “alternating motion” is intended to mean a movement between two positions based on which a body or a component is displaced between the first position and the second position, to return again to the first position. This movement can be performed for a single repetition or repeated for an indefinite number of times. Further, the trajectory between the two points may be the same in the outward path between the first position and the second position and in the return path between the second position and the first position. The trajectories that the bodies perform between the two positions can also differ between one repetition of the movement and another.

By the terms “substantially parallel” and “substantially perpendicular”, referred to two directions of motion or of development of two distinct bodies, it will be indicated, in the context of the present invention, a condition of parallelism and of orthogonality between the two directions, with a possible deviation of ±10°, preferably ±5°, with respect to a perfect parallelism and a perfect orthogonality, respectively.

By the term “substantially horizontal” referred to a direction, whether relative to the motion or to the development or to the arrangement of a body, it will be indicated, in the context of the present invention, a direction perpendicular to the direction of the force of gravity, with a possible deviation of ±10°, preferably ±5°, with respect to a perfect orthogonality, respectively.

By the term “to interconnect”, referred to two or more distinct components or bodies, it will be indicated in the context of the present invention the presence of a mechanical, electrical, or electromechanical connection between the two components or bodies that allows the movement to create a dependence relationship between the motion of one component and the motion of the other. This dependence relationship can be both such as to make the two components or bodies movable in an integral manner, i.e. movable with the same law of motion, and such as to make the motions of the two components or bodies simultaneous, i.e. movable at the same time, however not necessarily with the same law of motion, and such as to make one component or body perform a motion in succession, according to a predetermined sequence, to the motion of the other body or component.

The interconnection can take place through a physical connection, for example a mechanical connection or a wiring, but also without a physical connection, for example through non-contact sensors that detect the motion of a component or body so as to transmit a signal that makes the other component or body perform a corresponding motion.

By the term “substantially simultaneously” referred to an expression of motion, it will be indicated below that two components or bodies move together, at the same time.

Simultaneity may affect the entire path of motion or a part thereof, therefore it being sufficient that during the displacement of the two components or bodies there is an instant in which there is an overlap in their motion.

The Applicant, in the context of the constant need to increase the performance and the efficiency of the production processes, has preliminarily observed how, in a production line for making a coil, the winding speed of the strip-shaped article used to form the coil can constitute an important element limiting the production capacity of the line itself.

Furthermore, this limitation is even more critical if high precision is required in the formation of the coil. In particular, the Applicant has observed that in many applications, such as for example in the sector of the production of electrochemical cells, high precision in the geometry of the windings must be ensured in order to ensure the required performance of the finished product.

However, the Applicant has observed that there are inherent limits in the speed of advancement, and consequently of winding, linked both to the materials used for the formation of the coils, and to the technologies available for the applications in question.

In order to increase the speed for making the coil by means of a strip-shaped article, the Applicant has therefore perceived that this can be achieved by using more than one winding head, each aimed at forming a respective coil.

The Applicant has therefore further perceived how it is possible to increase the production capacity of a production line for making coils by providing for the feeding of two distinct strip-shaped articles, each intended to form a respective coil.

Finally, the Applicant has found that by keeping the strip-shaped articles appropriately separated, at least during their winding for the formation of the coil, it is possible to increase the production capacity of the line, without having to give up the required precision in both geometry and dimensional terms.

Thanks to these features, it is possible to optimally exploit the production capacity of a production line, it being possible to provide for one or more additional movements of the winding heads, without the use of two distinct strip-shaped articles causing particular complexity in the management of the advancement of the individual strips, and the feeding of a single base strip, which is subsequently separated into two parts, each intended to form a respective strip-shaped article and relative coil without introducing particular complexity into the structure of the apparatus.

In a first aspect thereof, therefore, the present invention is directed to an apparatus for making coils, preferably for electrochemical cells intended for battery production.

Preferably said apparatus comprises a feed unit configured to feed at least a first strip-shaped article preferably intended to form a first coil and a second strip-shaped article preferably intended to form a second coil.

Preferably said apparatus comprises a winding unit comprising a plurality of winding heads and including at least a first winding head configured to wind the first strip-shaped article and a second winding head configured to wind the second strip-shaped article.

Preferably said first winding head and said second winding head define respective winding axes substantially parallel to each other.

Preferably said apparatus comprises at least one movement device of said winding heads configured to move said first winding head and said second winding head.

Preferably said winding unit is configured so as to define a separation plane between said first winding head and said second winding head.

Preferably said separation plane is substantially perpendicular to said winding axes.

Preferably said separation plane is positioned so that said first strip-shaped article and said second strip-shaped article are located one on one side and the other on the opposite side of said separation plane at least at said first winding head and said second winding head.

Thanks to these features, the apparatus for making coils of the present invention can carry out a substantially simultaneous winding of two distinct coils. This therefore allows greater productivity at the same winding speed of the strip-shaped article and/or at the same feeding speed of the strip-shaped article to the winding head.

At the same time, the strip-shaped articles can be kept separated with respect to said separation plane during their winding to form the two distinct coils.

In this way the flow of the first strip-shaped article and that of the second strip-shaped article, as well as of the strip-shaped strip(s) forming the same, can be kept separated.

The arrangement of the separation plane allows at the same time to maintain the flows adjacent, allowing to use a configuration that suitably lends itself to carrying out the winding operations both with the heads in a static position, i.e. only with rotary motion around the relative winding axis, and in movement, for example with a linear translation motion.

In addition, this configuration also makes it possible to easily carry out cutting operations on the strip(s) or on the strip-shaped article, for example allowing the division of a single flow into two distinct flows or simultaneous works on adjacent edges of the two strips or strip-shaped articles separated by the separation plane.

In a second aspect thereof, the present invention concerns a method for making coils, preferably for electrochemical cells intended for battery production.

Preferably said method comprises providing a first strip-shaped article and a second strip-shaped article.

Preferably said method comprises winding said first strip-shaped article so as to form a first coil and said second strip-shaped article so as to form a second coil.

Preferably said first strip-shaped article and said second strip-shaped article are wound around respective winding axes substantially parallel to each other.

Preferably said first strip-shaped article and said second strip-shaped article are separated by said separation plane at least during said winding.

Preferably said separation plane is substantially perpendicular to said winding axes.

The method according to this aspect also allows to increase the production capacity in a coil production line, allowing to carry out the simultaneous winding of two distinct coils.

This therefore allows greater productivity at the same winding speed of the strip-shaped article and/or at the same feeding speed of the strip-shaped article to the winding head.

Furthermore, in analogy with the previous aspect, the first strip-shaped article and the second strip-shaped article can be advanced along two distinct paths, at least in part separated by the separation plane. This makes it possible to envisage optimal advancement trajectories to increase the speed of the strip-shaped articles and/or to reduce the tension states thereof that may occur during the operations required to form the coil.

In a third aspect thereof, the present invention is directed to an apparatus for making coils, preferably for electrochemical cells intended for battery production.

Preferably said apparatus comprises a feed unit configured to feed at least a first strip-shaped article preferably intended to form a first coil and a second strip-shaped article preferably intended to form a second coil.

Preferably said apparatus comprises a winding unit comprising a plurality of winding heads and including at least a first winding head configured to wind the first strip-shaped article and a second winding head configured to wind the second strip-shaped article.

Preferably said apparatus comprises a device for interconnecting said first winding head with said second winding head.

Preferably said interconnecting device is configured so that said first winding head and said second winding head perform substantially simultaneously, at least partially, one or more of: a rotation about the respective winding axis, a translation, a rotation about a further rotation axis different with respect to said winding axes.

Alternatively, said interconnecting device is preferably configured so that said second winding head performs, in succession to said first winding head, according to a predetermined sequence one or more of: a rotation about the respective winding axis, a translation, a rotation about a further rotation axis different with respect to said winding axes.

Thanks to the characteristics of the invention, based on this aspect, it is possible to envisage the presence of two different winding heads that operate, in a simultaneous or in any case coordinated manner, in the case of subsequent movements, for making two distinct coils.

In this way it is possible to obtain greater productivity at the same winding speed of the strip-shaped article and/or at the same feeding speed of the strip-shaped article to the winding head.

It will also be appreciated that the winding heads can both be moved according to specific trajectories during the winding of the strip-shaped article or possibly even preliminarily or subsequently to such winding, for example while feeding the strip-shaped article or unloading the coils once made or also other operations on the coils themselves.

In a fourth aspect thereof, the present invention concerns a method for making coils, preferably for electrochemical cells intended for battery production.

Preferably said method comprises providing a first strip-shaped article and a second strip-shaped article.

Preferably said method comprises winding said first strip-shaped article so as to form a first coil and said second strip-shaped article so as to form a second coil.

Preferably said method comprises interconnecting said first winding head with said second winding head so as to substantially simultaneously move said first winding head and said second winding head, or so as to move according to a predetermined sequence said second winding head in succession to said first winding head.

It will be appreciated that on the basis of this aspect it is possible to achieve results and benefits corresponding to those described in relation to the previous aspect.

In a fifth aspect thereof, the present invention is directed to an apparatus for making coils, preferably for electrochemical cells intended for battery production.

Preferably said apparatus comprises a feed unit configured to feed at least a first strip-shaped article preferably intended to form a first coil and a second strip-shaped article preferably intended to form a second coil.

Preferably said apparatus comprises a winding unit comprising a plurality of winding heads and including at least a first winding head configured to wind the first strip-shaped article and a second winding head configured to wind the second strip-shaped article.

Preferably said apparatus comprises at least one delivery device, configured so as to deliver a base strip, and at least one separating device configured so as to separate said base strip to form a first strip and a second strip intended to form said first strip-shaped article and said second strip-shaped article respectively.

Thanks to these features, it is possible to use a single strip, that is, the base strip, for feeding and making two distinct coils.

For example, the base strip can be collected in a specific coil that is gradually unwound and separated to form two distinct strips.

In this way, it is sufficient to feed a single strip to be able to make, possibly substantially simultaneously, two distinct coils.

Consequently, this aspect of the invention also contributes, at a general level, to the increase in the productivity of the apparatus, always with the same winding speed of the strip-shaped article and/or with the same feeding speed of the strip-shaped article to the winding head.

In a sixth aspect thereof, the present invention concerns a method for making coils, preferably for electrochemical cells intended for battery production.

Preferably said method comprises providing a first strip-shaped article and a second strip-shaped article.

Preferably said method comprises winding said first strip-shaped article so as to form a first coil and said second strip-shaped article so as to form a second coil.

Preferably said method comprises delivering a base strip and separating said base strip to form a first strip and a second strip intended to form said first strip-shaped article and said second strip-shaped article respectively.

It will be appreciated that on the basis of this aspect it is possible to achieve results and benefits corresponding to those described in relation to the previous aspect.

In a seventh aspect thereof, the present invention is directed to an apparatus for making coils, preferably for electrochemical cells intended for battery production.

Preferably said apparatus comprises a feed unit configured to feed at least a first strip-shaped article preferably intended to form a first coil and a second strip-shaped article preferably intended to form a second coil.

Preferably said apparatus comprises a winding unit comprising at least one winding head configured to wind the first strip-shaped article and the second strip-shaped article.

Preferably said apparatus comprises at least one delivery device, configured so as to deliver a base strip, and at least one separating device configured so as to separate said base strip to form a first strip and a second strip intended to form said first strip-shaped article and said second strip-shaped article respectively.

Thanks to these features, it is possible to use a single strip, that is, the base strip, for feeding two distinct strips intended to make a coil.

For example, the base strip can be collected in a specific coil that is gradually unwound and separated to form two distinct strips.

In this way it is sufficient to feed a single strip to be able to make, for example, the two separators that are used in the manufacture of the electrochemical cells.

Moreover, thanks to the characteristics of the invention based on this aspect, it is possible to simplify the manufacture of double-start coils, that is, in which there are two pairs of conductor strips and two pairs of relative separators wound in a coil in an alternating configuration.

In addition, this aspect of the invention may allow to adapt machines intended to make one-start coils also to the use for making coils with two or more principles, by separation of the base strip.

In an eighth aspect thereof, the present invention concerns a method for making coils, preferably for electrochemical cells intended for battery production.

Preferably said method comprises providing a first strip-shaped article and a second strip-shaped article.

Preferably said method comprises winding said first strip-shaped article and said second strip-shaped article so as to form a coil.

Preferably said method comprises delivering a base strip and separating said base strip to form a first strip and a second strip intended to form said first strip-shaped article and said second strip-shaped article respectively.

It will be appreciated that on the basis of this aspect it is possible to achieve results and benefits corresponding to those described in relation to the previous aspect.

The present invention, in at least one of the aforementioned aspects, may have at least one of the further preferred features indicated below.

Preferably, said first strip-shaped article is wound by a first winding head and said second strip-shaped article is wound by a second winding head.

Thanks to this feature, the two coils can be made in two distinct positions and substantially simultaneously or independently of each other. It will be appreciated that the two winding heads, for example when aligned on the same axis, may have components in common, as well as being formed by different zones of the same body or element.

Preferably, the winding axis of said first winding head and the winding axis of said second winding head are substantially coaxial. Preferably said first winding head and said second winding head are arranged side-by-side to each other along an axis coinciding with said winding axes.

In this way, it is possible to conveniently use two parallel flows of strip-shaped articles, and possibly of strips, which can be moved in a mirror-like manner with respect to the separation plane to make the two coils.

Consequently, it will be possible to make substantially simultaneously two coils, possibly with identical characteristics, by operating in parallel with a consequent increase in the productivity of the apparatus.

It will also be appreciated that when the winding axis of said first winding head and the winding axis of said second winding head are substantially coaxial, a single winding axis remains defined, ideally subdivided into two parts, the respective axes of the two heads being coincident.

Preferably, each of said winding heads is configured to rotate about a respective axis of said winding axes.

Preferably, said winding unit is configured to rotate each of said winding heads around a respective axis of said winding axes.

Thanks to these features, the winding of the strips takes place through the rotation of the heads themselves, with a constructional simple solution, which allows to obtain high winding speeds.

Preferably said winding heads are translated and/or rotated about a further rotation axis different from said winding axes during said winding said first strip-shaped article and said second strip-shaped article.

Preferably, said movement device is configured to move said first winding head and/or said second winding head according to at least one translation and/or a rotation about an axis different from said winding axes.

The Applicant has observed that by providing for further movements for the winding heads, in addition to their rotation for winding the coils, it is possible to optimise the operations for making the coils, both during feeding, during winding, and during unloading the coils once they have been made, or during other operations performed on the coils.

Preferably, said at least one translation and/or rotation takes place while winding said first strip-shaped article and/or said second strip-shaped article.

The provision of a movement during winding is particularly advantageous as it may allow to control the flow of the strip-shaped article and/or of the strip(s) forming the same so as to limit the generation of unwanted tension states or, more generally, to increase the productivity of the apparatus.

Preferably it is provided to interconnect said first winding head with said second winding head so as to substantially simultaneously move said first winding head and said second winding head, or to move according to a predetermined sequence said second winding head in succession to said first winding head.

Preferably, said apparatus comprises a device for interconnecting said first winding head with said second winding head.

Thanks to these characteristics, it is possible to provide for an interconnection between the two winding heads, whether mechanical or electro-mechanical or purely electronic, so that the motion of one is dependent on, or in any case coordinated with, that of the other.

For example, the interconnection can be such that the two winding heads move simultaneously, performing similar trajectories of motion or not, or that the motion of one head is followed by the motion of the other head, according to a predetermined order and trajectory.

Again by way of example, in this second case it may be provided that a first winding head performs a movement, stops, and immediately after the second winding head performs a respective movement.

Preferably said substantially simultaneously moving said first winding head and said second winding head, or moving according to a predetermined sequence said second winding head in succession to said first winding head, comprises one or more of: rotating said winding heads about respective winding axes, translating said winding heads, rotating said winding heads around a further rotation axis different from said winding axes.

Preferably said interconnecting device is configured so that said first winding head and said second winding head perform substantially simultaneously one or more of: a rotation about the respective winding axes, a translation, a rotation about a further rotation axis different with respect to said winding axes.

Preferably said interconnecting device is configured so that said second winding head performs, in succession to said first winding head, according to a predetermined sequence, one or more of: a rotation about the respective winding axes, a translation, a rotation about a further rotation axis different from said winding axes.

It will be appreciated that through the interconnection of the two winding heads during the aforementioned movements it is possible to provide for making two distinct coils, with two flows of parallel and separated strip-shaped articles and/or strips, without the envisaged movement being an obstacle to the advancement of strips and relative strip-shaped articles.

Preferably said further rotation axis different from said winding axes is an axis substantially parallel to said winding axes.

This solution allows the winding heads to be easily displaced from a zone where the strip-shaped article is fed and wound, to another zone, for example for unloading the coil thus made. At the same time more than two winding heads can be provided, so that while two winding heads perform the winding of two respective coils, other winding heads are in a different zone, for example in an unloading zone, and vice versa.

Preferably, said apparatus comprises four winding heads.

Preferably, said apparatus comprises six winding heads.

In this way, two or three pairs of winding heads can be provided respectively, of which one pair performs the winding of the strips and another pair is for example in an unloading zone. In the event that six winding heads are present, a third pair is in an intermediate zone, so as to reduce the rotation angle that the heads must perform to pass from the winding zone to the next one, for example to an unloading zone, without however excessively affecting the overall dimensions of the apparatus.

Preferably, said winding unit is configured so that said first winding head and said second winding head substantially simultaneously wind, at least partially, said first strip-shaped article and said second strip-shaped article, respectively.

Thanks to this feature, the two coils can be made substantially simultaneously, allowing productivity to be increased at the same feed and winding speed, as well as making the most of any movements envisaged for the winding heads, which in this way can be carried out simultaneously for the two heads.

Preferably, said interconnecting device comprises a mechanical connection.

In this way, a high synchronism between the two winding heads can be more easily guaranteed.

Preferably, said mechanical connection comprises a support body configured to rotatably support said winding heads.

Preferably, said support body is rotatable about a rotation axis substantially parallel to said winding axes.

Thanks to this feature it is possible to rotate both heads around a further rotation axis, for example substantially parallel to the winding axes so as to displace both winding heads from a zone where the winding of the strip-shaped article takes place, to a further zone, where the coils can for example be subjected to subsequent operations or be unloaded, and vice versa.

Preferably, said mechanical connection comprises a frame structure supporting said winding heads.

In this way, the connection can be made directly between a structure that supports both winding heads, thus making the two heads integral. As a result, the mechanical connection is particularly simple and robust.

Preferably, said support body is rotatably connected to said frame structure, said winding heads being supported on said frame structure by means of said support body.

Preferably, said frame structure is movable.

In this way it is possible to suitably combine the movements of the frame structure and support body, thus allowing the winding heads to perform various movements during winding and preliminarily to or subsequently to winding, by way of example by providing a linear motion during winding and a rotation to carry out, for example, the unloading of the coils after the strip-shaped article has been wound. In addition, this feature may also allow complex movements to be performed, for example formed by roto-translational movements.

Preferably, said substantially simultaneously moving said first winding head and said second winding head, or moving according to a predetermined sequence said second winding head in succession to said first winding head, comprises moving said first winding head and said second winding head in an alternating motion.

Preferably, said frame structure is configured so as to move according to an alternating motion.

Thanks to this feature, for example, it is possible to move the winding heads closer to and away with respect to a feeding zone or to an unloading zone or still to other zones where further operations are performed on the coils. This allows to appropriately control the advancement in the strip-shaped article and to accelerate the operation of making the coil, as it can allow to limit the occurrence of unwanted tension states.

Preferably said alternating motion comprises a translation along a translation axis.

The provision of a translation motion along a linear axis can allow to simplify the movement in the structure.

Preferably said translation axis is substantially horizontal.

A horizontal motion can be advantageous for an optimization of the overall dimensions and to improve the accessibility to the upper zones of the apparatus.

Preferably, it is provided to deliver a base strip and separate said base strip to form a first strip and a second strip intended to form said first strip-shaped article and said second strip-shaped article respectively.

Preferably said apparatus further comprises at least one delivery device, configured so as to deliver a base strip, and at least one separating device configured so as to separate said base strip to form a first strip and a second strip intended to form said first strip-shaped article and said second strip-shaped article respectively.

Thanks to these features, it is possible to use a single strip, that is, the base strip, for feeding and making two distinct coils. For example, the base strip can be collected in a specific coil that is gradually unwound and separated to form two distinct strips.

Preferably, said first strip and said second strip are separated by said separation plane.

Preferably, in the embodiments in which the first strip and the second strip are wound on a single winding head, for example in the case of solutions with two or more principles, said winding unit is configured so as to define a separation plane substantially perpendicular to said winding axis of said winding head.

In this way, the two flows can be conveniently separated already during the delivery of the strips, after the separation of the base strip into two parts.

This separation may be maintained for the entire path up to the winding heads, or alternatively the strips may modify their position with respect to the separation plane in one or more zones, for example by overlapping each other, so as to carry out specific operations at these zones.

Preferably, it is provided to move said second strip away from said first strip in a direction substantially perpendicular with respect to an advancement direction of said strips so that said first strip and said second strip are separated by said separation plane.

Preferably, said apparatus comprises diverting rollers configured so as to move said second strip away from said first strip in a direction substantially perpendicular with respect to an advancement direction of said strips and preferably substantially parallel to said winding axes.

This feature may in particular be advantageous in the case of separating the strips by cutting the base strip in order to move away the two sides of the strips which would otherwise remain close to each other after cutting.

Preferably, it is provided to move said second strip closer to said first strip in a direction substantially perpendicular with respect to said advancement direction of said strips so that said first strip and said second strip are substantially superimposed in a direction substantially parallel to said separation plane. Preferably said moving said second strip closer to said first strip is carried out after said moving said second strip away from said first strip.

Preferably, said apparatus comprises diverting rollers configured so as to move said second strip closer to said first strip in a direction substantially perpendicular with respect to said advancement direction of said strips and preferably substantially parallel to said winding axes.

Thanks to these features, it is possible to wind the strips on a single winding head, allowing a coil with two or more principles to be made, or to provide for the use of a single coil of base strip for making both separators of the electrochemical cell.

It is also possible to wind each strip on a respective winding head, using a single delivery of the base strip, thus simplifying the feed unit.

Preferably said diverting rollers are substantially cylindrical. Preferably said diverting rollers have a rotation axis inclined with respect to a direction substantially perpendicular to the separation plane for an angle a preferably comprised between 30° and 5°, preferably comprised between 25° and 10°, preferably comprised between 20° and 15°.

Preferably, said angle a is less than or equal to 30°, preferably 20°, preferably 15°, preferably 10°, preferably 5°.

Thanks to these characteristics, the diversion of the strips can be carried out with a particularly simple and reliable solution.

Preferably, it is provided to move said second strip away from said first strip in a direction substantially parallel to said separation plane.

Preferably, said apparatus comprises diverting rollers configured so as to move said second strip away from said first strip in a direction substantially parallel to said separation plane.

This feature may in particular be advantageous in order to allow the strips to be brought back parallel after their away-movement with respect to the separation plane.

In fact, their away-movement can be achieved by means of diverting rollers with an inclined axis.

Preferably, it is provided to move said second strip closer from said first strip in a substantially parallel direction with respect to said separation plane.

Preferably, said apparatus comprises diverting rollers configured so as to move said second strip closer from said first strip in a direction substantially parallel to said separation plane.

In this way, the strips can be brought back parallel and side by side, after having been separated at the separation plane.

Alternatively, it is possible to move them closer together so as to keep them superimposed on each other, for example to be wound on a single winding head in a solution with two or more principles.

It should be specified that some steps of the methods described above may be independent of the order of execution reported. In addition, some steps may be optional. In addition, some steps of the methods may be performed repetitively, or they may be performed in series or in parallel with other steps of the method.

The characteristics and advantages of the invention will become clearer from the detailed description of a preferred embodiment example thereof, illustrated by way of non-limiting example, with reference to the appended drawings wherein:

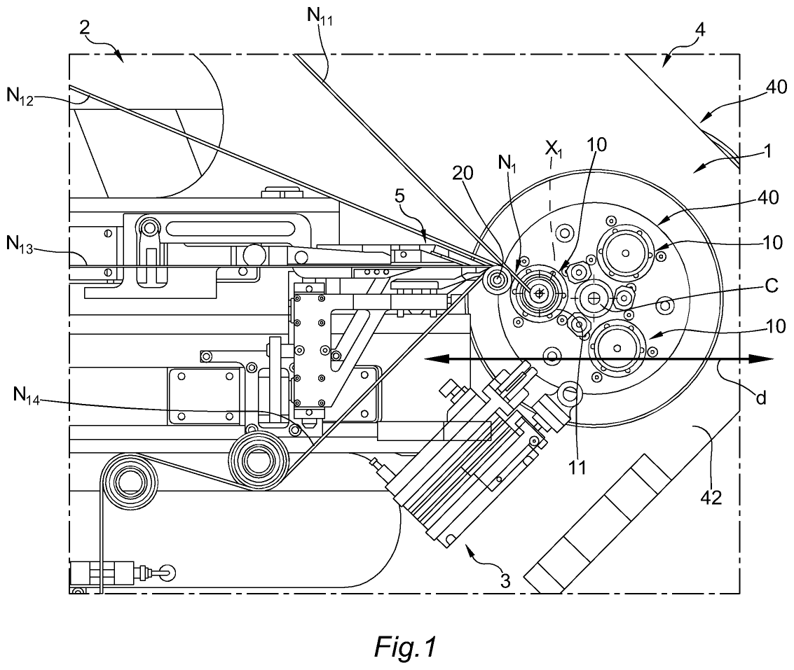

FIG. 1 is a side view, in detail, of the apparatus according to the present invention;

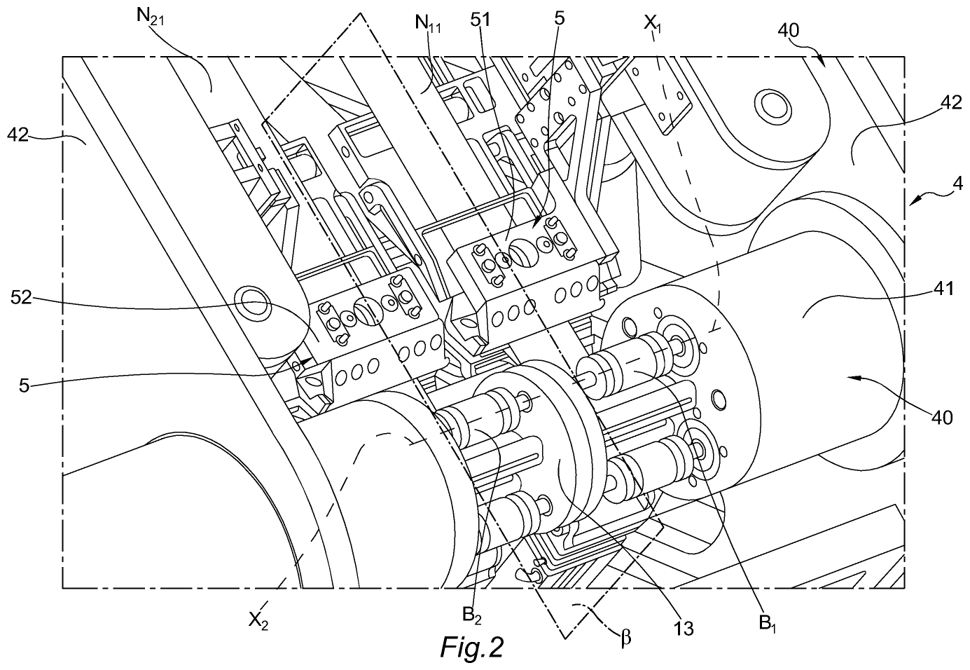

FIG. 2 is a perspective view of the apparatus of FIG. 1;

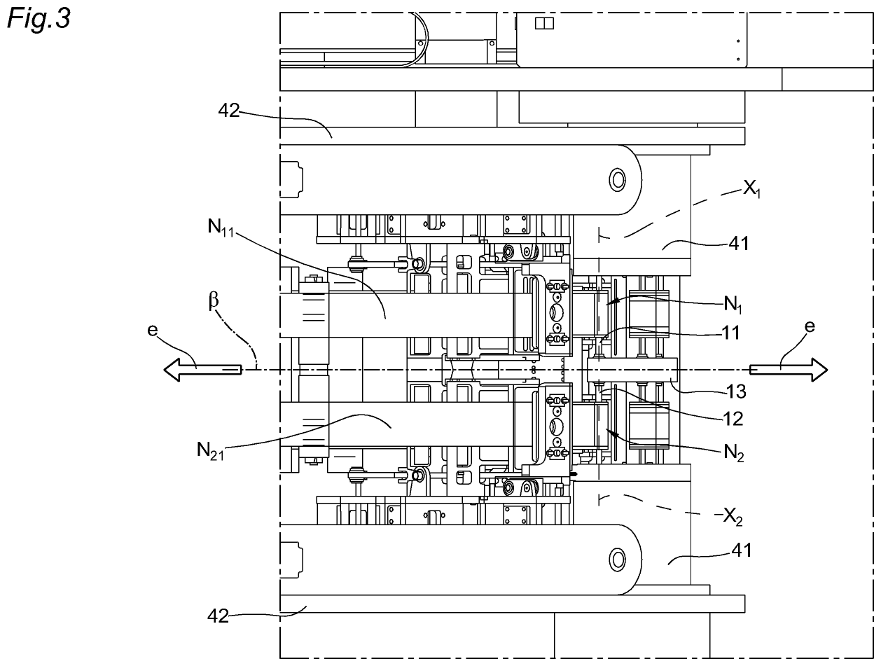

FIG. 3 is a plan view of the apparatus of FIG. 1;

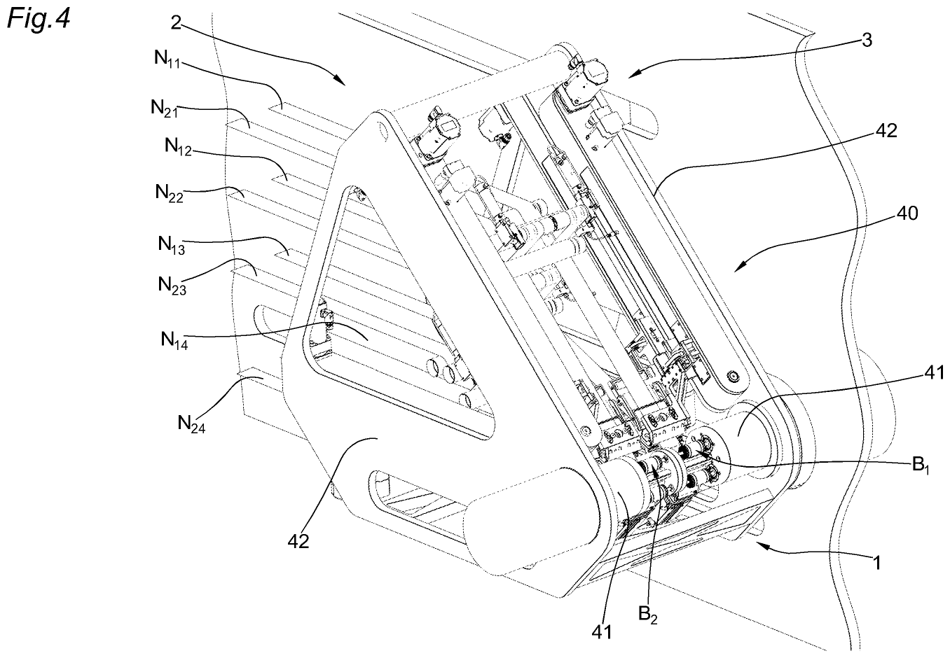

FIG. 4 a further perspective view of the apparatus of the present invention;

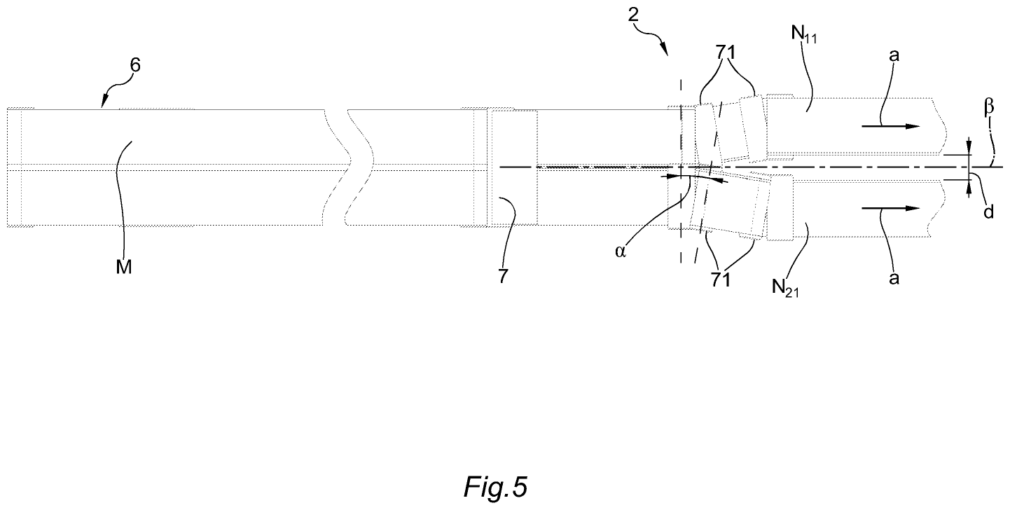

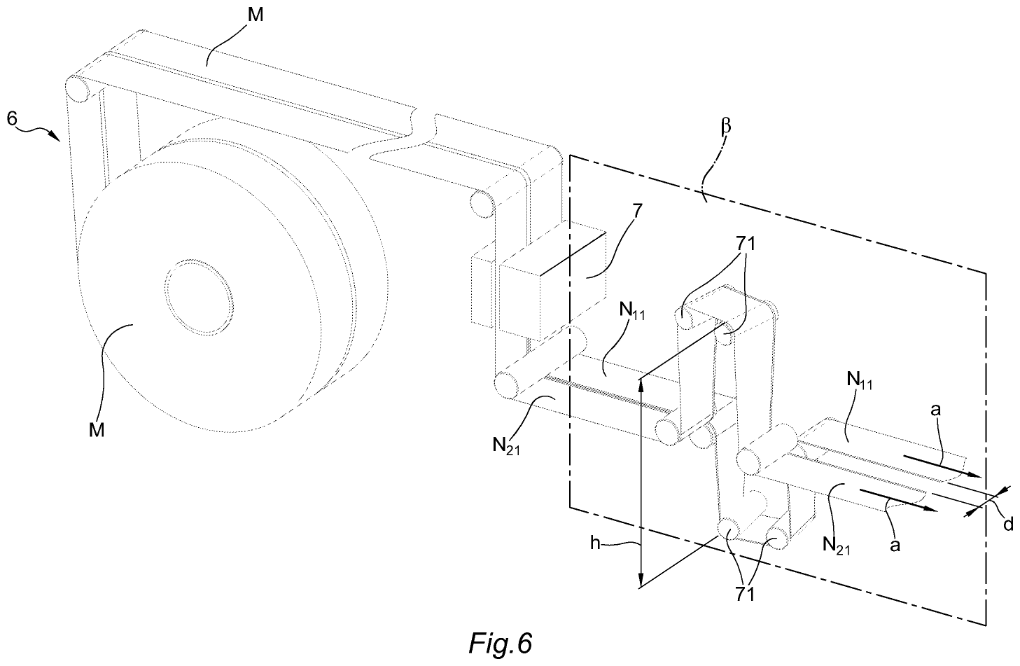

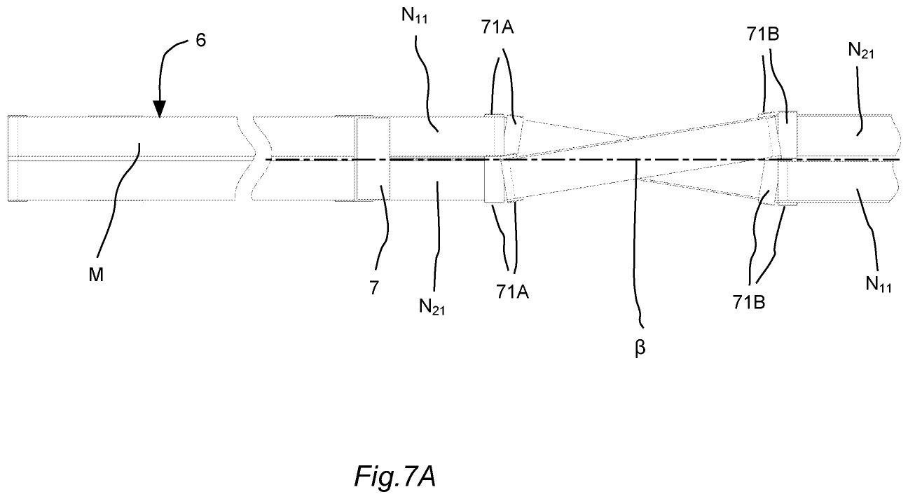

FIGS. 5 and 6 are respectively a plan view and a perspective view of a delivery device and of a separating device of the apparatus of the present invention;

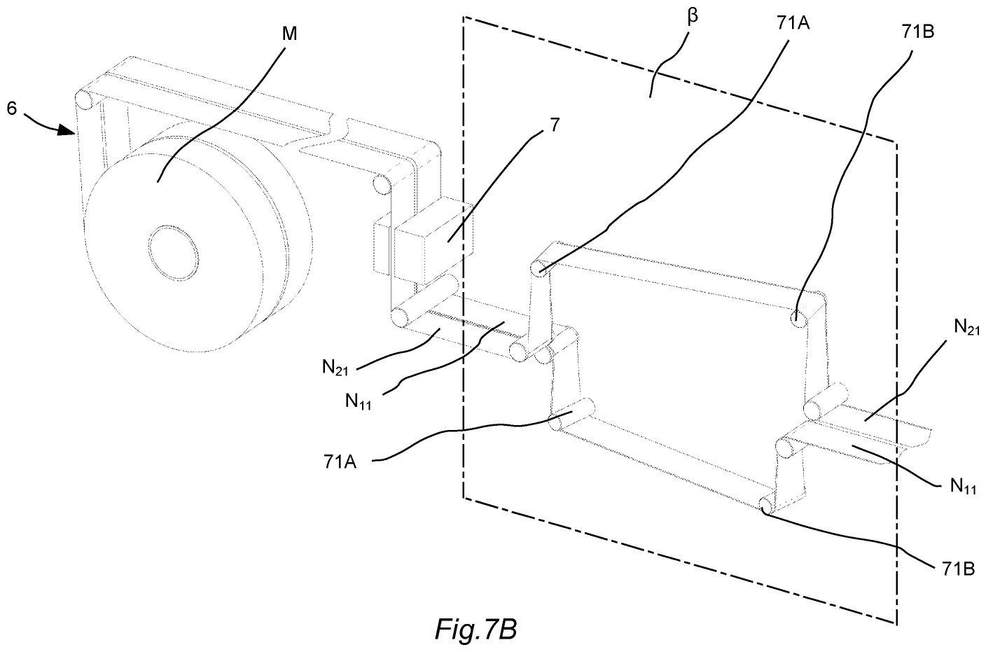

FIGS. 7A and 7B are respectively a plan view and a perspective view of a delivery device and of a separating device of the apparatus of the present invention according to an alternative embodiment;

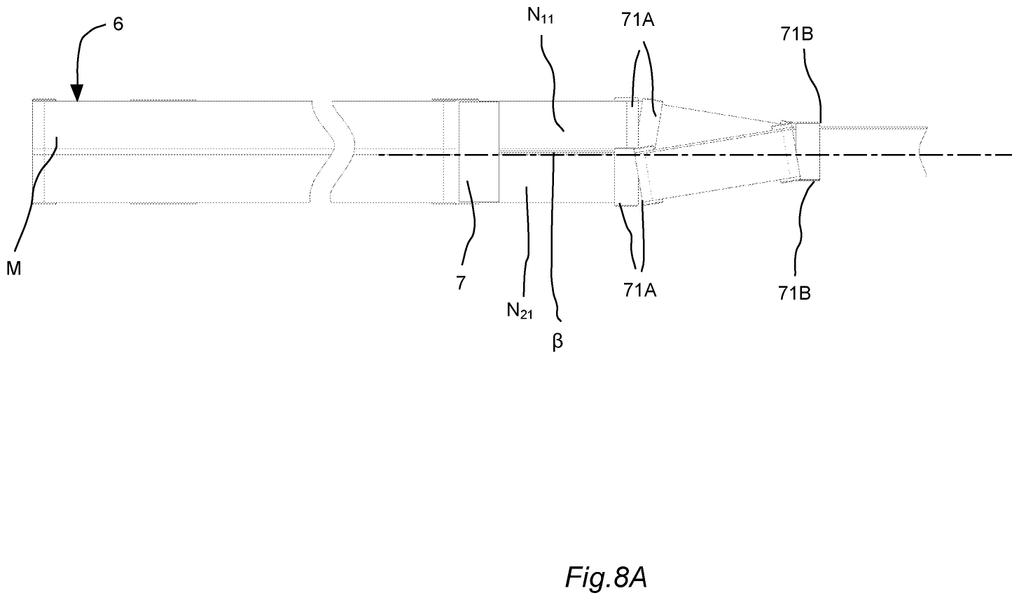

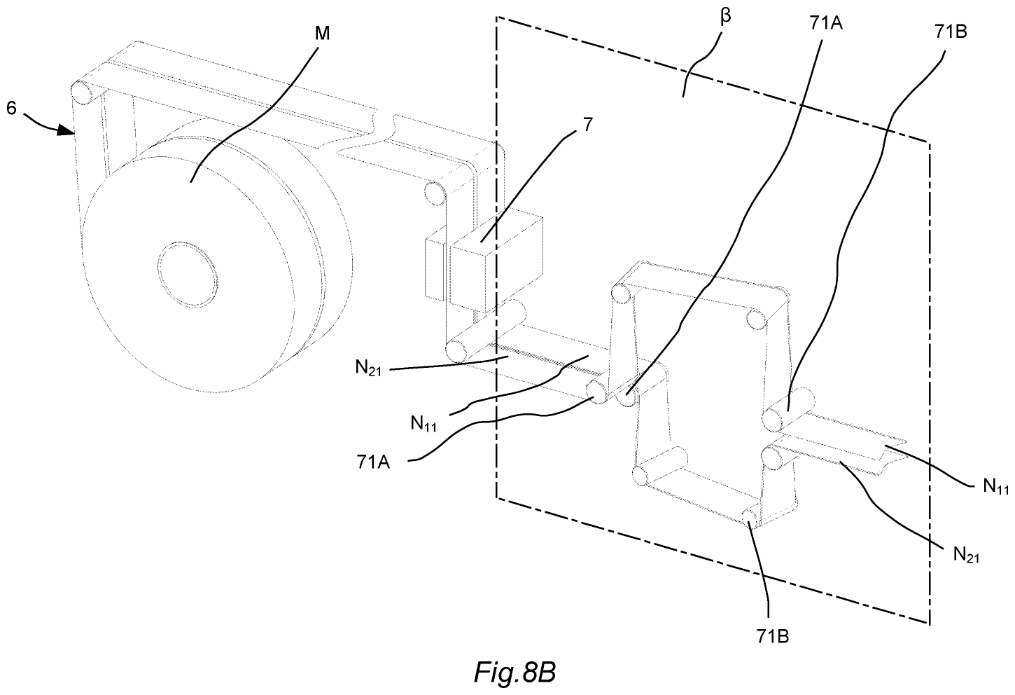

FIGS. 8A and 8B are respectively a plan view and a perspective view of a delivery device and of a separating device of the apparatus of the present invention according to a further embodiment.

With reference initially to FIGS. 4, 100 denotes as a whole an apparatus for making coils B1, B2 made in accordance with the present invention.

The apparatus 100 is advantageously made so as to make two distinct coils, indicated with the reference B1 and B2, respectively. As will be illustrated in greater detail below, in preferred embodiments such coils are made simultaneously, although it may also be contemplated that the two coils are made at different instants or only partially substantially simultaneously.

In preferred embodiments, the coils B1 and B2 are made by winding a respective strip-shaped article N1, N2, preferably intended to produce electrochemical cells.

However, it is understood that this represents a possible embodiment example and that the apparatus 100 according to the present invention may be intended to wind strip-shaped articles also intended for different uses, even in fields other than those related to the production of electrochemical cells.

For example, again in the field of energy storage, the present invention may find application in the manufacture of other rolled components intended for batteries or supercapacitors.

In some embodiments, such as the one illustrated in the figures, and in particular in FIG. 4, the apparatus 100 can be used within a line for the production of coil for electrochemical cells, in which each strip-shaped article N1, N2 is made through a combination of multiple strips preferably overlapped into layers.

For example, in the embodiment illustrated in the figures, each series of such strips advantageously comprises at least two conductor strips and two separator layers, which are arranged alternately to form the strip-shaped article.

In this way the separator strips can allow to keep the two conductor strips electrically separated from each other as they are spirally wound, forming the coil intended for the electrochemical cell.

It will be appreciated that in the figures the strips are indicated with the references N11, N12, N13, N14 as regards the first strip-shaped article and N21, N22, N23, N24 as regards the second strip-shaped article.

As can best be observed in the examples illustrated in FIGS. 2 and 3, in some embodiments each strip-shaped article is wound by a respective winding head. In other words, the first strip-shaped article N1 is preferably wound by means of a first winding head 11 and the second strip-shaped article N2 is preferably wound by means of a second winding head 12.

It will be appreciated that the coil B1 is made by winding through the first winding head 11 by winding the first strip-shaped article N1 around a winding axis X1, and the coil B2 is made through the first winding head 11, by winding the second strip-shaped article around a relative winding axis X2. Preferably, the winding of the strip-shaped articles N1, N2 takes place through a rotation of the respective winding heads 11, 12 about the relative winding axis. However, more complex movements, for example compound ones, may also be provided for performing the winding, also depending on the type of coil to be made.

As illustrated in FIG. 2, in some embodiments the winding axis X1 and the winding axis X2 are coaxial and essentially coincide with each other. Consequently, in embodiments that provide for the rotation of the winding heads 11, 12, these are de facto rotatable about the same rotation axis.

More generally, the winding axes of the winding heads may be substantially parallel to each other. It is evident that in this case the winding heads 11 and 12 will be able to rotate around different axes, even if parallel.

The winding heads 11 and 12 may be further configured so as to grasp the strip-shaped article for performing the winding thereof.

For this purpose each winding head 11, 12 can support a relative gripping device, not illustrated in the figure, which is configured to grasp a portion of a respective strip-shaped article N1, N2.

The winding of the strip-shaped article can thus be obtained by rotating the gripping devices. By grasping an end of the strip-shaped article N1, N2 or, more generally, a portion thereof, and by rotating said end or portion, it is in fact possible to wind the strip-shaped article obtaining a spiral configuration that forms the coil.

The winding unit 1 can therefore be configured to rotate each of the winding heads about the respective winding axis X1, X2, for example by means of a respective motor or by means of a single motor that imparts motion to both heads. More generally, the winding unit 1 can be configured so that the winding heads 11, 12 are moved according to rotation and/or translation movements to obtain the coils by winding the strip-shaped articles.

In alternative embodiments, not illustrated in the figure, the winding unit 1 may comprise arms that support the winding heads so as to move them along a working path. This working path may, for example, be a closed path that is cyclically travelled by the winding heads.

A separation plane β oriented substantially perpendicular to the winding axes X1, X2 is advantageously defined between the two winding heads 11, 12.

Such a plane may for example, in exemplary embodiments, be defined in an interface zone between the first winding head 11 and the second winding head 12.

The winding axis X1 and the winding axis X2 can in fact be constituted by respective shafts. The opposite ends of each shaft can for example be rotatably supported respectively on a support body 41 and on an auxiliary support 13, illustrated in FIG. 2. The auxiliary support 13 can then define an intermediate zone between the first winding head and the second winding head at which there is a separation interface between the two winding heads and which defines the passage position of the separation plane β.

It will however be appreciated that embodiments may be provided in which the auxiliary support 13 is not present and in which, for example, the two winding heads 11, 12 are formed by a single body. In this case the winding axes will be coincident and the two winding heads aligned along the direction defined by the same and will extend between two opposite support bodies 41. The separation plane β may advantageously be arranged as passing along the winding axis, in an intermediate zone, preferably corresponding to the centreline, between the two opposite support bodies 41. It should also be noted that in alternative embodiments a single support body 41 could be present, from which the winding heads extend, for example cantilevered. In this case, the separation plane β may pass through an intermediate point, preferably corresponding to the centreline, between the end at which one winding head is supported on the support body, and the opposite end of the other winding head, specifically corresponding to the free end.

It will also be appreciated that, in this case, the two winding heads 11 and 12 can be defined along the single body that forms them at the zones in which the first strip-shaped article and the second strip-shaped article are respectively wound.

With reference now again to FIG. 3, the separation plane β is generally positioned so that the first strip-shaped article N1 and the second strip-shaped article N2 are located one on one side and the other on the opposite side of the separation plane β itself.

As will be illustrated in greater detail below, in preferred embodiments the first strip-shaped article N1 and the second strip-shaped article N2, and preferably also the strip(s) forming the same, are always kept one on one side and the other on the opposite side of the separation plane β.

However, it will be possible to envisage that in at least one zone this condition does not occur and that therefore the strips cross or at least partially overlap one another.

However, it should be noted that in general the first strip-shaped article N1 and the second strip-shaped article N2 are kept one on one side and the other on the opposite side of the separation plane β at least at said first winding head 11 and said second winding head 12.

As can be observed from the figures, in some embodiments a plurality of winding heads 10 may be present, for example formed by several pairs of first and second winding heads.

For example, as can be observed from FIG. 1, there can be six winding heads 10, that is, three pairs of first and second heads, of which a first pair winds the strip-shaped article, a second pair is, for example, in an unloading position, in which the coils, once made, are unloaded, and a third pair is in an intermediate position.

As previously mentioned, each strip-shaped article N1, N2 can be made through a combination of several strips.

In some embodiments, the strips are supplied by special delivery devices 6. By way of example, FIG. 6 illustrates an embodiment example of the delivery devices 6, which can be formed by large-sized coils in which the strip is collected so as to be unwound and therefore supplied during the operation of the apparatus.

Each of the strips N11, N12, N13, N14, N21, N22, N23, N24 can be delivered by a respective delivery device or several strips can be delivered by a common delivery device.

In preferred embodiments, such as the one illustrated in FIGS. 5 and 6, a base strip M is delivered, which is separated to form a first strip N11 and a second strip N21 intended to form said first strip-shaped article N1 and said second strip-shaped article N2 respectively.

It will be appreciated that although a single delivery device 6 from which the base strip M is delivered is illustrated, delivery devices in equal numbers to the strips forming each strip-shaped article may be envisaged.

As can be observed from FIG. 5, once delivered by the delivery device 6, the base strip M can be directed towards at least one separating device 7 configured to separate said base strip M into the two aforementioned strips.

Preferably, the separation of the base strip takes place so that the first strip N11 and the second strip N21 are separated by the separation plane β.

The separation plane β can therefore be defined from the point in which the separating device 7 acts to divide the base strip M into two parts.

With reference now again to FIG. 4, the strips supplied by the delivery devices 6 are then supplied to a feed unit 2, illustrated only schematically in the figure.

It will be appreciated that the strips, before being supplied to the feed unit 2 can transit through further units for example intended to carry out preliminary works on the strips. For example, the conductor strips can be subjected to preliminary incision or ablation operations so as to shape a relative outer edge in order to favour the connections with the further conductor portions within the electrochemical cell. In some embodiments one or more of these preliminary operations may be carried out by the separating device 7 itself, if present. In other words, the separating device 7 can be used not only for the separation of the base strip M, but also for further works, such as works at the separation zone of the base strip, i.e. the two facing sides of the strips once separated. With reference again to FIG. 5, it is preferably provided to move the second strip N21 away from the first strip N11 in a direction substantially perpendicular with respect to an advancement direction a of said strips N11, N21.

The strips can still be kept separated by the separation plane β, despite being located at a greater distance from each other.

The away-movement between the two strips can take place both along a direction perpendicular to the separation plane β and in a direction parallel to the separation plane β or in a combination of the two directions.

For this purpose, the apparatus 100 may comprise diverting rollers 71 configured so as to move the second strip N21 away from the first strip N11 in the direction substantially perpendicular with respect to an advancement direction of said strips N11, N21 and preferably substantially parallel to said winding axes X1, X2.

In some embodiments the diverting rollers 71 are substantially cylindrical and have a rotation axis inclined with respect to a direction substantially perpendicular to the separation plane β for an angle a preferably comprised between 30° and 5°, preferably comprised between 25° and 10°, preferably comprised between 20° and 15°. In some embodiments, said angle α is less than or equal to 30°, preferably 20°, preferably 15°, preferably 10°, preferably 5°.

It will therefore be appreciated that the deviation of the strips, for example the strips N11 and N21 in FIGS. 5 and 6, with respect to a direction substantially perpendicular to the separation plane β may allow to increase the distance d between the two rollers with respect to the separation plane β itself.

Advantageously, this increase in distance allows the winding of the strip-shaped articles N1, N2 to be carried out in positions that are more spaced from each other with respect to the winding axis, allowing to reduce the risk of interferences between the two strip-shaped articles especially in the event that the two winding axes are substantially coincident.

The deviation of the strips with respect to a direction substantially parallel to the separation plane allows instead to increase the distance h with respect to a plane substantially parallel to the separation plane β itself.

This feature can for example be useful in the part of the path in which the strips are moved away with respect to the distance d, again to avoid interferences between the strips and better manage the presence of the spacer rollers. In this case the distance h can be reduced again, possibly bringing it back substantially to zero, and then making the two strips run side by side, after these have been separated according to the distance d.

The provision of a deviation of the strips with respect to a direction substantially parallel to the separation plane, i.e. of the distance h, may advantageously also allow to reverse the position of the first strip N11 and of the second strip N21, as illustrated in an exemplary embodiment in FIGS. 7A and 7B.

Preferably, diverting rollers 71A configured so as to move the strips away and diverting rollers 71B configured so as to move the strips closer together will be provided.

Advantageously, the diverting rollers 71A can be configured so as to increase the distance d and/or the distance h. Similarly, the diverting rollers 71B may also be configured to decrease the distance d and/or the distance h.

It will be understood that the distance d may be decreased with the aim of moving the strips closer together, while still keeping them separated, in order to reverse the strips, like in the embodiment of FIGS. 7A and 7B, or again in order to overlap the strips, like in the embodiment of FIGS. 8A and 8B illustrated below.

In some embodiments, such as for example the one illustrated in FIGS. 8A and 8B, the reduction of the distance d can in fact be used to obtain an at least partial overlap of the strips.

In the case illustrated in the figures, the strips are superimposed on each other so as to allow them to be wound on a single winding head or, alternatively, on two winding heads which are parallel but lying on the same plane perpendicular to their winding axis.

However, it will be appreciated that an even partial overlap of the strips may be provided, for example to carry out works involving opposite edges of each strip.

With reference now again to FIGS. 1 and 4, in preferred embodiments, the feed unit 2 feeds the individual strips N11, N12, N13, N14 and the individual strips N21, N22, N23, N24 of each group towards the winding unit 1, converging them towards the respective winding heads.

The strips N11, N12, N13, N14 and the strips N21, N22, N23, N24 of each group can be combined inside the feed unit 2 so as to form the strip-shaped articles N1, N2 to be wound for making the coils.

As can be observed in the embodiment example illustrated in FIG. 1, for this purpose it can be provided that the strips N11, N12, N13, N14 are advanced along different directions, indicated with the references f1, f2, f3, f4 in the figure, to converge towards a coupling roller 20, on which the rollers are coupled and at least one strip is partially wound so that, downstream of said strip, there is a single multilayer structure forming the strip-shaped article N1. A similar solution can also be provided for the strips N21, N22, N23, N24 which will therefore converge towards a respective coupling roller 20, which can possibly be formed as a single body with respect to the roller 20 to which the strips N11, N12, N13, N14 converge.

In some embodiments the coupling roller 20 may not be present and the strips be coupled to each other directly on the respective winding head.

Preferably the strips are fed continuously into the feed unit 2.

In other words, each strip, or possibly one or more of the aforementioned strips, is fed into the feed unit 2 without ever stopping, proceeding with a speed greater than zero and preferably substantially constant.

It should also be noted that in some embodiments, one or more of the strips N11, N12, N13, N14, N21, N22, N23, N24 may be slowed down or even stopped during its travel towards the coupling roller 20 or more generally towards the winding unit 1.

This slowing down or stopping can be carried out by means of a strip retaining device configured so as to slow down or stop feeding the strip it is wished to slow down or stop.

The retaining device 5 can possibly be associated with an accumulation device, not illustrated in the figure, configured to accumulate a quantity of strip if its feeding takes place continuously.

In other words, the action of the accumulation device can be coordinated with that of the retaining device 5 so that the accumulation device accumulates the strip when the retaining device slows down or stops feeding the strip.

For example, in some embodiments to slow down the movement of said strip portion, it can be provided for the presence of grippers 51, 52, or other similar retaining element, which acts on the respective strip in the moment in which it is required to be stopped or slowed down.

The gripper(s) 51, 52 can advantageously be movable, so as to adjust the advancement speed of the relative strip by controlling its movement.

The retaining device can also be associated with a cutting device, not illustrated in the figure, which if necessary cuts one of the strips, to create an interruption in the continuity of said strip within a strip-shaped article. It will be appreciated that there may be two cutting devices, each associated with a relative retaining device and therefore with a relative strip-shaped article, or a single cutting device in charge of cutting both strip-shaped articles.

The apparatus of the present invention further comprises a movement device 3 in charge of moving the winding heads 10.

Preferably, the movement device 3 is configured to move the first winding head 11 and said winding head 12 according to at least one translation and/or a rotation about an axis different from said winding axes X1, X2.

In some embodiments, the winding heads 11, 12 perform a translation along a displacement direction and, preferably in an alternating motion, during the winding of the strip-shaped article N1, N2 or, more generally, while making of the coil.

Preferably, possibly in combination with the aforementioned translation, the winding heads 11, 12 rotate around a further rotation axis different from said winding axes X1, X2.

Such rotation may for example be a rotation about an axis C substantially parallel to said winding axes X1, X2 and may be carried out to displace the coils, once the strip-shaped article has been wound, from a position in which the winding takes place to another position, for example an unloading position.

In some embodiments, it may be provided for a mechanical connection 40 configured to interconnect the first and second winding head so as to perform the aforementioned movements in a substantially simultaneous manner.

However, it will be appreciated that more generally it may be provided for interconnecting devices 4 also of a type different from a purely mechanical connection, for example of an electronic or electro-mechanical type.

Furthermore, the interconnecting device 4 can also be configured to provide, alternatively or in combination with a substantially simultaneous movement, also a sequential movement of the two heads, with a predetermined order and rate. For example, a first winding head 11 can be moved and, once the movement of the first winding head has been completed, the interconnecting device 4 can cause the movement of the second winding head 12.

As can be observed from the embodiment example of FIG. 1, the mechanical connection 40 preferably comprises a support body 41, rotatable around the axis C, configured to rotatably support said winding heads 10.

The rotatable body 41 is also advantageously movable, in addition to around its rotation axis C, also in a displacement direction and along which said rotatable body 41 and, in general, the movement device 3, can be displaced.

In other words, the movement heads 10 may in this case be displaced, in addition to rotating on themselves for winding the strip-shaped article N1, N2, also following the movement of the rotating body of the movement device 3, preferably the linear displacement thereof.

For this purpose, in some embodiments, the support body 41 is in turn supported on a frame structure 42, to which it is rotatably connected.

The frame structure 42 may in turn be movable, for example by performing the previously described translation movement.

In preferred embodiments, the movable frame structure 42 also supports the coupling roller 20, the retaining device 5 and the cutting device, if one or more of them are present, which can therefore also be moved together with the frame structure 42.

Although in the embodiment described in the figure the support body 41 allows the winding heads to be rotated simultaneously and the frame structure 42 allows to perform a translation thereof, the interconnecting device 4 can in general be configured so as to also provide for different movement combinations of the winding heads. In particular, it may be provided that the winding heads perform, simultaneously or sequentially, according to what is illustrated above, one or more of the following movements: rotate around the respective winding axes X1, X2, translate, rotate around a rotation axis different from the winding axes X1, X2.

These movements can also be combined with roto-translation motions.

For example, in the embodiments described above in which the winding heads are supported on arms, such translation and/or rotation about an axis different from the winding axis can be achieved through the movements of the arms. Of course, it may be provided that the winding heads rotate around the relative winding axis while moving along the working path defined by the translation/further rotation.

In this way it will be possible to perform the winding while the winding heads are moving, in analogy with the movement of the frame structure 42 that takes place in the embodiment illustrated in the figures.

It will also be appreciated that, if the winding heads are supported on arms, it may be provided that the distance between two successive feed heads along their working path is variable. For example, the two winding heads will be able to move closer together at the end of the winding of a coil, to cut the strip-shaped article, while they will be able to move away during the winding of the strip-shaped article.

It goes without saying that, in order to meet specific and contingent application needs, a person skilled in the art will be able to make further modifications and variants that are nevertheless within the scope of protection as defined by the following claims.

1. Apparatus for making coils for electrochemical cells intended for battery production, said apparatus comprising:
A feed unit configured to feed at least a first strip-shaped article intended to form a first coil and a second strip-shaped article intended to form a second coil;
A winding unit comprising a plurality of winding heads including at least a first winding head configured to wind the first strip-shaped article and a second winding head configured to wind the second strip-shaped article, said first winding head and said second winding head defining respective winding axes substantially parallel to each other;
At least one movement device of said winding heads configured to move said first winding head and said second winding head;
wherein said winding unit is configured so as to define a separation plane, said separation plane being substantially perpendicular to said winding axes and being positioned so that said first strip-shaped article and said second strip-shaped article are located one on one side and the other on the opposite side of said separation plane at least at said first winding head and said second winding head.

2. The apparatus of claim 1, wherein the winding axis of said first winding head and the winding axis of said second winding head are substantially coaxial.

3. The apparatus of claim 1, wherein each of said winding heads is configured to rotate about a respective axis of said winding axes

4. The apparatus of claim 1, wherein said winding unit is configured to rotate each of said winding heads around a respective axis of said winding axes.

5. The apparatus of claim 1, wherein said movement device is configured to move said first winding head and said second winding head according to at least one translation and/or a rotation about an axis different from said winding axes, wherein said at least one translation and/or rotation preferably takes place while winding said first strip-shaped article and/or said second strip-shaped article.

6. The apparatus of claim 1, comprising a device for interconnecting said first winding head with said second winding head.

7. The apparatus of claim 6, wherein said interconnecting device is configured so that said first winding head and said second winding head perform substantially simultaneously, at least partially, one or more of:
a rotation about the respective winding axes,
a translation,
a rotation about a further rotation axis different from said winding axes.

8. The apparatus of claim 1, wherein said winding unit is configured so that said first winding head and said second winding head substantially simultaneously wind, at least partially, said first strip-shaped article and said second strip-shaped article respectively.

9. The apparatus of claim 6, wherein said interconnecting device is configured so that said second winding head performs, in succession to said first winding head, according to a predetermined sequence, one or more of:
a rotation about the respective winding axes,
a translation,
a rotation about a further rotation axis different from said winding axes.

10. The apparatus of claim 6, wherein said interconnecting device comprises a mechanical connection.

11. The apparatus of claim 10, wherein said mechanical connection comprises a support body configured to rotatably support said winding heads.

12. The apparatus of claim 11, wherein said support body is rotatable about a rotation axis substantially parallel to said winding axes.

13. The apparatus of claim 10, wherein said mechanical connection comprises a frame structure supporting said winding heads.

14. The apparatus of claim 11, wherein said support body is rotatably connected to said frame structure, said winding heads being supported on said frame structure by said support body.

15. The apparatus of claim 13, wherein said frame structure is movable.

16. The apparatus of claim 15, wherein said frame structure is configured so as to move according to an alternating motion, preferably a translation.

17. The apparatus of claim 16, wherein said translation is substantially horizontal.

18. The apparatus of claim 1, further comprising at least one delivery device, configured so as to deliver a base strip, and at least one separating device configured so as to separate said base strip to form a first strip and a second strip intended to form said first strip-shaped article and said second strip-shaped article respectively.

19. The apparatus of claim 18, wherein said first strip and said second strip are separated by said separation plane.

20. The apparatus of claim 19, comprising diverting rollers configured so as to move said second strip away from said first strip in a direction substantially perpendicular with respect to an advancement direction of said strips and preferably substantially parallel to said winding axes.

21. The apparatus of claim 1, comprising four winding heads and preferably six winding heads.

22. Method for making coils, for electrochemical cells intended for producing batteries, said method comprising:
providing a first strip-shaped article and a second strip-shaped article,
winding said first strip-shaped article so as to form a first coil and said second strip-shaped article so as to form a second coil, said first strip-shaped article and said second strip-shaped article being wound about respective winding axes substantially parallel to each other;
wherein said first strip-shaped article and said second strip-shaped article are separated by a separation plane at least during said winding, said separation plane being substantially perpendicular to said winding axes.

23.-32. (canceled)
